(19) United States
(12) Patent Application Publication
(10) Pub. No.: US 2005/0038766 A1
(43) Pub. Date: Feb. 17, 2005

(54) Agent-based personal object management

(75) Inventors: David F. Bantz, Bedford Hills, NY (US); Thomas E. Chefalas, Somers, NY (US); David C. Frank, Ossining, NY (US); Steven J. Mastrianni, Unionville, CT (US); Ajay Mohindra, Yorktown Heights, NY (US); Vijay K. Naik, Pleasantville, NY (US); Norbert G. Vogl, Mahopac, NY (US)

Correspondence Address: Louis P. Herzberg;Intellectual Property Law Dept., IBM Corporation, P.O. Box 218, Yorktown Heights, NY, 10598, US

(73) Assignee: International Business Machines Corporation, Armonk, NY (US)

(21) Appl. No.: 10/639,098

(22) Filed: Aug. 12, 2003

(51) Int. Cl. G06F 7/00

(52) U.S. Cl. 707/1

(57) ABSTRACT

This invention provides systems, apparatus and methods for object management, employing agents for all personal computer objects. Personal objects survive in direct proportion to the degree to which they possess attributes that give them a competitive advantage in the use of the computing systems storage and name spaces. It employs an important competitive attribute of future utility. Since it is not always possible to accurately predict future utility, assessment of competitive advantage is based on secondary attributes that can be computed and that correlate with future utility, to a greater or lesser degree. It uses a ‘coordinating mechanic’ that monitors and controls relationships between personal objects and their agents. The term “object management” applies to computer systems, but is not necessarily limited to computer entities

### FIELD OF THE INVENTION

This invention is directed to computer management. It is more specifically directly to personal computer object management.

### BACKGROUND OF THE INVENTION

In the early days of personal computing the capacity of storage devices was limited to a few hundred or perhaps a thousand files at most. Although it was arguably more important to reuse storage space occupied by files which were no longer necessary, the number of files was small enough so that the end user could retain some idea of their utility and use that idea when doing housekeeping. File attributes such as the date of last update, the file type and the file name helped jog the user's memory as to what each file was for, and perhaps the task that the user was doing when the file was current. But today's file capacities are such that a given user may have a million files. It is beyond any user's capabilities to be able to judge whether a given file is likely to have future use, or can be deleted. The motivation for file deletion has changed, too. Rather than delete files to reclaim storage space, today's user deletes files in order to make migration to another platform easier. Storage maintenance is also performed to reduce confusion, and the likelihood that new activities will begin by communicating or modifying the wrong documents.

We use the term “personal object” here, primarily, to refer to any entity that has a recognizable identity, such as a file, a folder, a bookmark, a cookie or any other entity on which maintenance activities such as deletion may be performed. The challenge of personal object management is to retain all objects with continuing value, and to dispose of all objects without continuing value in order not to add to the complexity of future maintenance activities. In the Windows® family of operating systems there are utilities provided to help with object maintenance. The Disk Cleanup utility, for example, looks for files in certain types of folders (e.g., the Recycle Bin, Temporary Internet Files) and offers to delete them on behalf of the user. A common user strategy is to list all files in order of size or age, with the idea that old files are the most likely not to be needed again, and large files give the greatest space benefit when they are deleted. However, effective tools for personal object maintenance are, for the most part, lacking.

U.S. Pat. No. 5,634,124 Khoyi et al. is concerned with object-oriented computing, and in particular for creating infrastructure by which data integration may be achieved. Object managers are associated with each class of data and are responsible for finding ways that data can be communicated between unlike classes. This patent is not concerned with object maintenance and does not maintain unique attributes with each object, those attributes correlated with future utility.

U.S. Pat. No. 5,862,325 Reed et al. is concerned with the communication of computer data accompanied by metadata, or data about the data. The file attributes that are a feature of the current invention are an example of metadata. In this patent, Reed et al. are concerned with controlling the communication of data in accordance with the metadata. This patent is not concerned with object maintenance. In a continuation of this patent, U.S. Pat. No. 6,088,717 extends Reed to include databases, but does not teach the subject of object maintenance.

In U.S. Pat. No. 6.044,205, Reed et al. further considers metadata-driven communication and adds the element of object method communication, so that the destination of such data can provide object-specific processing of the received data. Again, this patent does not teach personal object maintenance.

Finally, in U.S. Pat. No. 6,240,405, Suzuki describes means by which an automatic selection among a plurality of agents is done based on an agent table. The goal of this patent is to provide an end-user interaction facility wherein said interaction takes place with the facial features and voice of a specific human agent. This patent does not concern personal object maintenance.

### SUMMARY OF THE INVENTION

Thus to solve this problem, personal objects survive in direct proportion to the degree to which they possess attributes that give them a competitive advantage in the use of the computing systems storage and name spaces. An important competitive attribute is future utility. Since it is not always possible to accurately predict future utility, we base an assessment of competitive advantage on secondary attributes that can be computed and that correlate with future utility, to a greater or lesser degree. Categories of objects are themselves objects, so that whole collections of objects can be thought of as having greater or lesser competitive advantage. Once the survival attributes of all objects are known, decisions or recommendations can be made affecting maintenance.

An aspect of the present invention to automatically score personal objects objectively and in accordance with criteria predictive of future utility, and to make recommendations or to take direct action concerning the deletion and archiving of a subset of personal objects deemed to have low potential for future utility.

Another aspect of this invention is the provision of methods for the automatic scoring of personal objects and the use of those scores to make recommendations for the deletion or archiving of certain objects whose scores are low relative to other such objects.

### BRIEF DESCRIPTION OF THE DRAWINGS

These and other objects, features, and advantages of the present invention will become apparent upon further consideration of the following detailed description of the invention, by way of example only, when read in conjunction with the drawing figures, in which:

FIG. 1 shows an abstraction of a personal computing device called a “personal object space”;

FIG. 2 shows an implementation of the personal object space depicted in FIG. 1;

FIG. 3 shows three example templates that contain information pursuant to the choice of agent class for a given object;

FIG. 4 depicts a process by which the class of an agent is chosen for a particular object;

FIG. 5 shows an exemplary implementation of a matching procedure that is not customized to object type;

FIG. 6 shows processing that a context object performs to associate a newly created object with a particular context;

FIG. 7 shows a possible procedure by which an agent can generate a report;

FIG. 8 shows a personal object space containing personal objects with associated agents; and

FIG. 9 shows processing performed by a global mechanic.

### DESCRIPTION OF THE INVENTION

This invention provides systems, apparatus and methods for object management. It takes its lead from Darwin's theory of natural selection. In this theory, species survive by possessing or developing attributes that give them a competitive advantage with respect to other species, in those circumstances where the species compete for some shared resource. By analogy, we reason that personal objects should survive in direct proportion to the degree to which they possess attributes that give them a competitive advantage in the use of the computing systems storage and name spaces.

An important competitive attribute is future utility. The future utility of an object is the likelihood of any kind of use of that object at any time in the future, preferably expressed as a probability p. The complement of this probability, (1−p), is the probability of no future use of that object. An object with p=0 is an object which can be destroyed without future consequence. Since it is not always possible to accurately predict future utility, we base an assessment of competitive advantage on secondary attributes that can be computed and that correlate with future utility, to a greater or lesser degree. Categories of objects are themselves objects, so that whole collections of objects can be thought of as having greater or lesser competitive advantage. Once the survival attributes of all objects are known, decisions or recommendations can be made affecting maintenance.

In an example embodiment, this invention automatically scores personal objects objectively and in accordance with criteria predictive of future utility, and makes recommendations and/or takes direct action concerning the deletion and archiving of a subset of personal objects deemed to have low potential for future utility.

The invention disclosed here implements methods for the automatic scoring of personal objects and the use of those scores to make recommendations for the deletion or archiving of certain objects whose scores are low relative to other such objects.

The value of this invention to the user is the elimination of the need to manually select personal objects for deletion or archiving, an especially difficult and error-prone task because of the lack of objective criteria on which to make such decisions. The user realizes a significant reduction in the complexity of his or her personal computing environment, reducing conceptual load and increasing user satisfaction. Maintenance actions can be taken automatically if the scoring accurately predicts future utility; recommendations for action can be given if the scoring does not exhibit sufficient protection against deletion of objects with future utility.

The invention includes a program that runs on a personal computing device. This program keeps track of all of the personal objects present on the personal device. It maintains and evaluates attributes associated with each of the objects. In an advantageous embodiment, the program includes classes that are instantiated into agents, one agent for each personal object. The agent is responsible for the acquisition of information about the object, the storage of attributes derived from that information, and the competition with other agents to ensure its object's survival.

Periodically agents evaluate the survival value of their objects and engage in a competition whose outcome is recommendations for the archive or deletion of objects with low survival value. The survival value can be computed by each agent, but preferably, all agents submit a multi-dimensional survival index to an arbitrator, who uses current policy as a way to decide among the competitors. In this way the calculation of survival value can vary from time to time in accordance with the needs and wishes of the user.

Each class is associated with a different type of personal object. For example, an object containing data intended to be reproduced as a sound, and in particular as music, would be associated with a class specific to music and knowledgeable about the ways in which that object is normally used. Music files are rarely edited, most often being read only. The absence of editing operations on music files would not be indicative of future utility, whereas the absence of editing operations on other files (e.g., indices) might indicate that these files have limited future utility.

In an advantageous embodiment, objects are associated with a context, or a setting in which the object is created and used.

The “context” of a personal object is a set of personal objects having some association with the personal object, grouping personal objects whose future utility is related to the future utility of the personal object. For example, if the text of a patent application were stored in a personal object, and the figures of the same patent application were stored in other personal objects, the set of personal objects containing the text object and all of the figure objects would be preferably the context of each of the personal objects stored therein. The rationale for the construction of this set and the representation of it as the context of each of its constituent objects is that if the text object is used in the future then it is likely that the figure objects will be used as well, and vice versa.

Furthermore, for example, if an object were created in response to the user's assumption of a new task, other objects may also be created and modified in the execution of that task. The task becomes the motivating source of the creation of a context, with which all of the objects are associated. The context is itself a personal object, containing all of the objects that are associated with it. The purpose of this abstraction is to capture the relationship between a context and a task, such that when the task is done the context may or may not lose survival value, depending on whether the task has a persistent outcome. In other words, knowledge of the task state (e.g., completed) means that there are maintenance implications for its context.

As used herein, the term “object management” applies to computer systems, but is not necessarily limited to computer entities. Thus, for example, suppose a business wants to manage its inventory. If, instead of storing the inventory data in a database, the business chooses to represent each item as an object. Then the principles of this application apply. Objects scoring low would cause their objects to be candidates for sale on a Web site such as that of eBay, while one would want to retain items whose objects score high. Another example, is when one thinks of employees in a corporation as items in an inventory and represent them as objects.

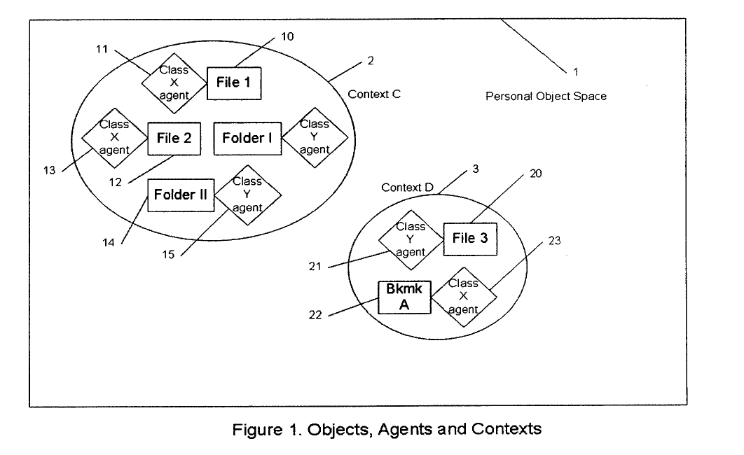

An advantageous embodiment of the invention including a description of the method employed is shown in the accompanying figures. FIG. 1 shows an abstraction 1 of a personal computing device called a “personal object space.” A personal object space is a conceptual space in which personal objects exist. In a typical personal computing device, personal objects are stored in the file system, which is on a storage device like a hard disk. Personal objects can be files, folders, bookmarks, or any other distinguishable entities subject to maintenance. Shown also are two contexts 2 and 3. Contexts associate personal objects, as previously described. Within context 2 are four objects, files 10 and 12 and folders 14 and 16. Associated with each object is an agent. For example, File 10 has agent 11 associated with it, that agent being an instance of class X. Within context 3 is shown two objects 20 and 22 with associated agents 21 and 23.

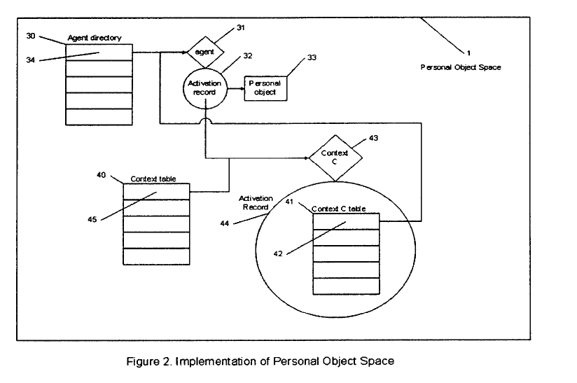

FIG. 2 gives an implementation of the personal object space depicted in FIG. 1. Shown in FIG. 2 is one personal object 33 in personal object space 1. This personal object has agent 31 associated with it, and is a member of context C (FIG. 1 context 3). Agents are located with agent directory 30, whose entry 34 locates agent 31. Agent 31 is an instantiated object with activation record 32, one component of which is data that locates personal object 33. This data may be a path to personal object 33 or a handle to that object. It is by this means that personal object 33 is associated to agent 31. Activation record 32 also contains data pertaining to the future utility of personal object 33 and contains a reference to the object's context 43. Personal object 33 is a member of context C by virtue of its association with agent 31. Agent 31 is located by entry 42 of context table 41. Context C is implemented as object 43, located by entry 45 of context table 40. The activation record of object 43 is activation record 44 that contains context table 41 for context C. This activation record also contains data pertinent to the future utility of all of the objects in context C.

In a further advantageous implementation, agent directory 30 is implemented as an instance of a concrete subclass of the Java class List, as are context table 40 and context C table 41. Agent 31 is implemented as a particular subclass of the Java class Object, as is the context object 43. A compact introduction to the Java language and its classes can be found in the book “Java in a Nutshell,” by David Flanagan, published by O'Reilly press. Again, in an advantageous implementation, agent 31 implements the Java interface Runnable. Objects implementing this interface can be run as threads, or independently schedulable lightweight processes.

To evaluate the survival value of each object, what is necessary is for some program to sequence through the agent directory 30, creating a thread for each entry and calling the appropriate methods of agent objects, for example agent object 31. Each agent will run and compute a survival value based on information about the agent's object and on information about its context. Alternatively, agents can be designed to run continuously once a thread has been allocated to them. With this design, agents can monitor their objects by receiving events from system components and applications that interact with these objects.

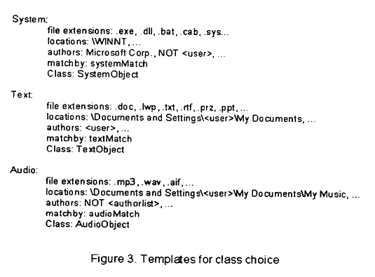

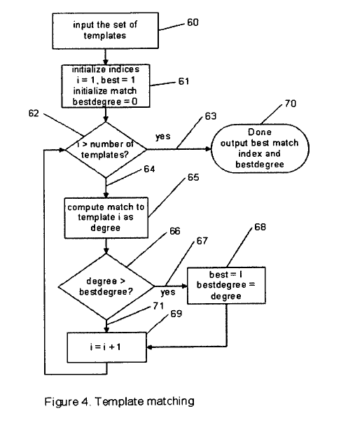

All agents are instances of one of several classes, the class being chosen according to the type of the personal object. To implement this choice the preferred embodiment stores templates, as shown in FIG. 3. FIG. 3 shows three example templates that contain information pursuant to the choice of agent class for a given object. The three templates are for system, text and audio objects and can apply to bookmarks as well as to files. Each template has five fields: a list of file extensions indicative of the object class, a list of locations indicative of the object class, a list of authors indicative of the object class, the name of a matching procedure and the name of the object class to instantiate an agent from. The procedure depicted in FIG. 4 can be used together with these and other templates to determine the agent class.

FIG. 4 depicts a process by which the class of an agent is chosen for a particular object.

In block 60 the set of all templates is input and stored in a form that is efficient for searching and matching. Block 61 initializes two indices: the first, i, is the index of the template under current evaluation as a match for the given object. The second, best, is the index of the template that has currently the best match for the given object. Block 61 also initializes a variable, bestdegree, which will hold the best degree of match. Block 62 checks to see if i exceeds the maximum index over all templates. If so, branch 63 is taken to block 70 and processing terminates with best holding the index of the best match and bestdegree holding its match degree. If not, branch 64 is taken to block 65 to compute the match between the object and template i. In block 66 the degree of this match is tested and if greater than that of the current best match, branch 67 is taken to block 68 to make the current template the best. If the degree of match is not better than that of the current best match in block 66, branch 71 is taken to block 69, selecting the next template for matching. In processing not shown in FIG. 4, if the best degree of match does not exceed a given threshold the agent class is assigned to a default class. Otherwise the agent class is assigned to the class of the best match template.

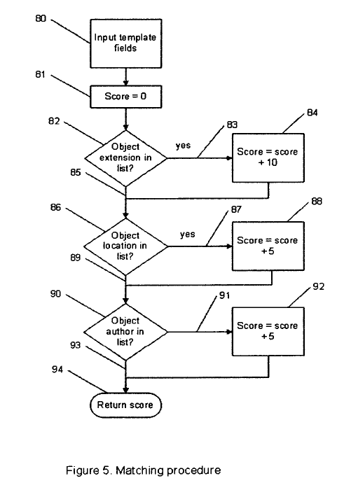

The matching process itself is a procedure found referenced in the template in the field “matchby.” The field contents contain the name of the matching procedure, which can be located by table lookup in a manner familiar to those skilled in the programming art. FIG. 5 shows an exemplary implementation of a matching procedure that is not customized to object type. Processing in FIG. 5 begins with block 80, which inputs the various fields (file extension list, location list, author list) of the template. In block 81 a scoring variable is initialized. Block 82 tests to see if the object file extension matches an entry in the file extension list and, if so, branch 83 is taken to block 84 where the scoring variable is increased by 10. If not, branch 85 is taken. Regardless, block 86 tests whether the object location matches an entry in the location list and, if so, branch 87 is taken to block 88 where the scoring variable is increased by 5. If not, branch 89 is taken.

Regardless, block 90 tests whether the object author matches an entry in the author list and, if so, branch 91 is taken to block 92 where the scoring variable is increased by 5. If not, branch 93 is taken. Regardless, block 94 is entered to return from the matching procedure.

It may be the case that, as in FIG. 3 in the template for audio, a list entry specifies NOT. This modifier may be present on any list element. Considering block 90 of FIG. 5, if the object author matched an entry in the author list with the NOT modifier, the processing in block 92 would be modified to subtract 5 from the scoring variable rather than adding to it. Also note that the values 10, 5 and 5 in blocks 84, 88 and 92, respectively, need not be constants but can be obtained by any means including table lookup.

Different agent classes maintain different information about each object. This information may include, but is not limited to, information about the time of creation, last modification and last access to the object; the size of the object, and the “cost to recreate” of the object. An object is costly to replace if no copy of the object exists anywhere, and if the object cannot be reconstructed by any known means. An object is inexpensive to recreate if backup or archive copies of the object exists, or if the object was derived from two or more objects that are available, by a known procedure. Each class of object may use different procedures or criteria to estimate its cost to replace. For example, a music file in .mp3 format may be irreplaceable if it was created by the end user, while if created by a company in the recording industry that file could be recreated by purchasing a new copy, or by reference to a music-sharing service.

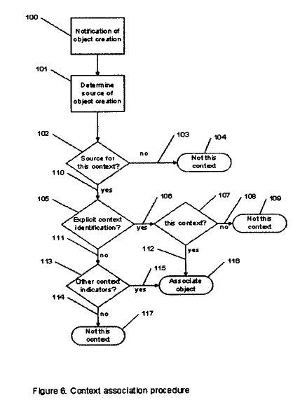

Context is one way by which an estimate of future utility may be obtained. Context is an association of objects together with summary information about that association. The summary information is maintained by the context object in its activation record, as in activation record 44 of context object 43 in FIG. 2. Preferably, context reflects user activities that create and update several objects. The context object contains logic that helps determine whether a given object should be associated with that context. An example of that logic is given in FIG. 6. This logic is invoked by the creation of a new object. Either the initialization of the new object must consult all of the context objects to determine which one is the most appropriate to associate to, or preferably context objects register with the various means by which objects are created and monitor object creation. If a context object determines that a newly created object should be in its context the object can call a method on that object's agent to register itself as the context that the object should be associated with.

FIG. 6 illustrates processing that a context object performs to associate a newly created object with a particular context. This processing begins with block 100 when the context object is notified of a new object creation. Each context object must subscribe to notifications of object creation, but only for those objects that can be associated with the given context. In block 101 the source of object creation is determined from the notification. Block 102 determines if the source of object creation is one of the sources that can create objects in this context. If not, branch 103 is taken to block 104 that terminates processing. If so, branch 110 is taken to block 105. Block 102 takes care of the case that this context can contain objects newly added to the file system, for example, but not objects created by the Windows Media Player. Block 105 checks to see if the notification contains an explicit identification of the desired context of the object. This would be the case for application programs, for example, which are aware of an implementation of the subject invention and can actively facilitate it. One of the ways that such an application can actively facilitate personal object maintenance is to identify the context of newly created objects.

If block 105 finds explicit context identification, branch 106 is taken to block 107, which further tests whether this context is so identified. If not, branch 108 is taken to block 109 which terminates further processing. If so, branch 112 is taken to block 116 which associates the given object with this context. In the case that there is no explicit context identification, block 105 takes branch 111 to block 113 which tests for other context indicators. Examples of other context indicators include, but are not limited to, file names which are similar to other file names of file objects in this context, file locations which are locations of other files in this context, a time of creation very close to that of the time of creation of other files in this context, and many other possible context indicators. If block 113 finds the presence of other context indicators branch 115 is taken to block 116, previously described. If no other context indicators are found branch 114 is taken to block 117 which terminates further processing.

In general, agents serve to monitor and characterize their objects for the purposes of object maintenance. Agents may subscribe to receive events from the computer operating system's file system to be instantly aware of accesses or changes made to a file object, for example. This event reception is made possible by facilities in the Windows operating system, for example. The Microsoft .NET framework contains a subsystem that supports subscription to and notification of events of various types, accessed through the NET System.Management namespace. For additional information see the library on the Microsoft Web site.

Agents can report an estimate of the future utility of their objects in various ways. The report can be an integer or floating-point value in a defined range, representing the relative future utility. Preferably, this report should be accompanied by an estimate of the certainty of that value. For example, if the report is a floating-point value in the range (0, 1.0) a given agent may report an estimate of 0.3 of future utility, a cost to replace of 0.9, and a confidence of 0.8. This object is likely to be retained because the cost to recreate it is high, the confidence in that cost and in the estimate of future utility is high, and there is a non-zero estimate of future utility. This type of reporting is exemplary and is not limiting to the type of reporting possible in the subject invention.

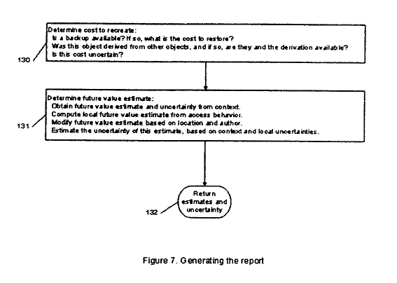

FIG. 7 shows one possible procedure by which an agent can generate a report. In block 130 the cost to recreate the object is determined, as previously discussed. In block 131 the estimate of future value is made. As previously discussed, this estimate will be different for different object types and agent classes. The estimate is made based on estimates from the context and from locally maintained attributes of the object. The estimate is modified by other locally maintained attributes. A simple computation can be expressed as follows, expressed in the Java programming language:
ESTIMATE=0.0;
IF (OBJECT.RECENTLY_ACCESSED) ESTIMATE=ESTIMATE+0.1;
IF (OBJECT.AUTHOR==USER) ESTIMATE=ESTIMATE+0.1;
ESTIMATE=ESTIMATE+CONTEXT.ESTIMATE;
IF (ESTIMATE>1.0) ESTIMATE=1.0;

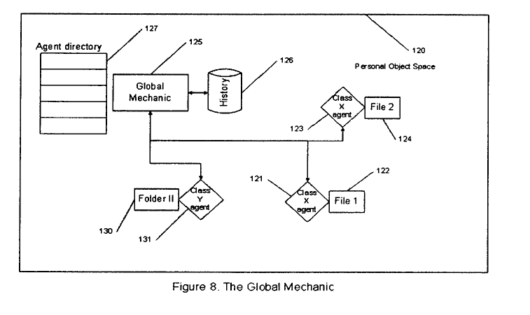

It remains to be described how maintenance decisions are made on the basis of these reports. To this end the subject invention introduces a unique object, the Global Mechanic (GM). The relationship between personal objects and their agents, on the one hand, and the GM, on the other, is shown in FIG. 8. FIG. 8 depicts a personal object space 120 containing personal objects 122, 124 and 130 with associated agents 121, 123 and 131, respectively. The space also contains GM 125. In FIG. 2 an agent directory 30 was shown and described by the accompanying text. Here, the agent directory 127, which is the same as the agent directory 30 of FIG. 2, is shown again. The GM 125 has the responsibility to maintain and access the agent directory 127. In addition, GM 125 maintains a persistent history 126 for purposes to be described.

In the figure it can be seen that bi-directional communication exists between GM 125 and agents 121, 123 and 131. In the first phase of this communication, the GM initiates the creation of a report, as described above. In the second phase of this communication, the GM receives reports from all agents. These reports can be in the form described above or in any form sufficient to allow the GM to make maintenance decisions. The GM refers to the agent directory 127 to locate each agent. The history 126 is for the purposes of weighting the various reports, as will be described subsequently.

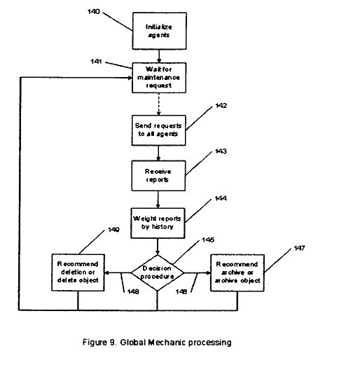

The processing performed by the GM is shown in FIG. 9. In block 140 the GM uses agent directory 127 of FIG. 8 to initialize all of the agents, preferably by allocating a thread to each one. In block 141 the GM waits for a maintenance request. Maintenance requests can occur at fixed times according to a schedule, or can be triggered by a high storage device utilization condition, or can be invoked by the user, or in other ways. When the maintenance request arrives block 142 is entered and sends requests to all agents, preferably by calling a known method supported by all agents. In block 143 the agents return their reports, of the form as previously described. Block 144 weights each report by history, discounting agents with a history of overly optimistic or pessimistic reports. Block 145 then evaluates all of the reports with a decision procedure. The decision procedure can be as complex as required, or can be as simple as computing a score based on the reports and comparing that score against two thresholds: the lower threshold determines whether the object should be deleted, and the higher threshold determines whether the object should be archived and deleted from its current location. If the object is to be deleted without archiving it, branch 148 is taken to block 149 that either recommends deletion or accomplishes deletion, at the user's option. If the object is to be archived branch 146 is taken to block 147 that either recommends archiving or accomplishes archiving, at the user's option. Then block 141 is entered to await the next maintenance request.

It can be seen that the description given above provides a simple, but complete implementation of automatic or semiautomatic personal object maintenance. If the memory requirements of the agents is too great, the implementation can be modified to use one agent for a collection of personal objects rather than one agent per object. Agents do not have to be run as independent threads but can be invoked synchronously by the GM. The various decisions described can be made using different and more sophisticated decision procedures, including decision procedures that change over time as the user's preferences become known. For example, if the maintenance is performed through recommendations rather than directly, the outcome of each user decision can be tracked and used to modify thresholds in the decision processes. Similarly, estimates of future utility taken at a point in time can be recorded and compared with access behavior between that point in time and a later point in time. If the estimates are found inaccurate this knowledge can be fed back to the procedures which compute the estimates of future utility. Agent classes need riot be determined by the characteristics of the templates of FIG. 3, but can be determined by other methods including direct designation by the end user.

The subject invention can be also embodied as a service in several ways. In one services embodiment, a service provider contracts with the user of a personal computer system for the management of the personal objects stored therein. The provider supplies software to the user which must be installed on his or her personal computer. That software discovers and enumerates all of the personal objects stored on the personal computer system. This software is known in the programming art as software that performs an inventory, and is commonly used for asset management. An example of software capable of performing such an inventory is IBM Director, described in the book “Implementing Systems Management Solutions with IBM Director,” available at the IBM ‘redbooks’ Web site, www.redbooks.ibm.com.

After an inventory of personal objects has been taken, the service provider then supplies additional software to the user which must be installed. This software consists of the classes of agents, together with an initialization procedure that is performed to instantiate agents for each of the inventoried personal objects. These classes are constructed so as to be capable of communicating to the service provider, preferably using the Internet. The service provider implements a Web service for the Global Mechanic which periodically communicates with each agent, requiring that agent to report on the status of its personal object. Once reports from all personal objects have been received by the Global Mechanic an analysis is performed to determine candidates for destruction. That report is made available to the end user by first notifying the end user of the existence of a new report, preferably by e-mail. The e-mail contains the URL of a Web page maintained by the service provider containing the report. The end user can then examine the report and select from its recommendations. Destruction of personal objects can be performed by the end user using facilities of the personal computer operating system, or can be performed through a procedure in which selections from the report are sent to software maintained by the service provider. That software can communicate with selected agents by sending them a command to destroy the objects associated with those agents, using programming interfaces available from the personal computer operating system.

Thus, one embodiment of the present invention is an object management system interconnecting with a communications fabric. The system including a plurality of personal objects. The objects being any of files, folders, bookmarks, preferences, annotations, or any such. The system further includes a plurality of agents. Each agent associated with at least one particular personal object from the plurality of personal objects, and each particular personal object associated with at least one such agent. Each agent providing supervision and maintenance of the particular personal object, wherein supervision consists of recording any or all actions taken on the personal object by any program and maintenance consists of providing recommendations for or taking direct action to migrate, copy or delete the object; a coordinating mechanic to control each of the plurality of agents. The coordinating mechanic functioning to initiate the preparation of a report from each said agent, to summarize the plurality of such reports, and to make comparisons between the reports for the purpose of determining maintenance actions to be taken on the personal objects with which the agents are associated. Messages between the coordinating mechanic and each of the plurality of agents is transported via the communications fabric. The system having at least one scoring module to compute a score indicative of a relative probability of future utility of each particular object from the plurality of personal objects, and a decision module to make system decisions based upon at least the relative probability.

In some embodiments, the object management system further includes a survival module to allow a particular object to survive in direct proportion to a degree to which the particular object possesses attributes indicating a competitive advantage in use of computing systems storage and name spaces; and/or the coordinating mechanic includes a plurality of peer mechanics to control each agent, each peer mechanic being associated with a particular agent; and/or the at least one scoring module is used by each of the agents; and/or a communications fabric capable of carrying messages between peer mechanics; and/or the coordinating mechanic associates a coefficient for each agent based upon at least one coefficient weighting criterion, the decision module makes system decisions also based upon each coefficient; and/or the at least one coefficient weighting criterion includes coefficient weighting criteria taken from a group of coefficient weighting criteria including: historical accuracy, agent class, an agent's own confidence estimate, a randomly chosen quantity biased by any of the above and any combination of these; and/or the decision module forms a sum of products of each particular object's relative probability and each particular object's coefficient.

In further embodiments, the messages include messages from each agent to the coordinating mechanic. Each message having information taken from a group of information including: an estimate of future utility of each particular object, a cost of maintaining each particular object, a confidence factor of the estimate of future utility of each particular object, and any combination of these.

In some embodiments, the method includes the step of: associating at least a portion of the plurality of personal objects with at least one context, the context being an association or grouping of other personal objects together with information associated with the association or grouping; and/or creating the at least one context based on execution of a task, wherein each context forming a groups of objects such that all of the objects in the group of objects are associated with the task; and/or creating the at least one context based on the originator or recipient of each of a group of objects such that all of the objects in the group of objects are associated with the originator or recipient of the objects; and/or creating at least one other object in response to a user's assumption of a new task; and/or creating at least one other object in response to a user's designation of originator or recipient; and/or the relative probability is a measure of a future utility level of the particular object; and/or at least one of the plurality of agents provides at least one explanation of information computed by each agent; and/or at least one of the plurality of agents and the coordinating mechanic is provided by a service; and/or the coordinating mechanic is provided by a Web service.

Another embodiment of the present invention is a method including the steps of: providing a plurality of personal objects, forming a plurality of agents, each agent being associated with a particular personal object from the plurality of personal objects, each agent providing supervision and maintenance of the particular personal object, controlling each of the plurality of agents with a coordinating mechanic transporting messages between the coordinating mechanic and each of the plurality of agents, computing a score indicative of a relative probability of future utility of each particular object from the plurality of personal objects, and making system decisions based upon at least the relative probability. In some embodiments, the method includes forming the coordinating mechanic as a unique global mechanic.

Still another embodiment of the present invention is an architecture for a computer system comprising: a plurality of personal objects; a plurality of agents, each of said agents being associated with and coupled to a unique personal object from said plurality of personal objects, each agent providing supervision and maintenance of said unique personal object; a coordinating mechanic for controlling each of said plurality of agents; a communications fabric coupled to said coordinating mechanic for transporting messages between said coordinating mechanic and each of said plurality of agents; at least one scoring module coupled to said communications fabric for computing a score indicative of a relative probability of future utility of each particular object from said plurality of personal objects; and a decision module coupled to said communications fabric for making system decisions based upon at least said relative probability.

In some embodiments, the architecture includes a survival module allowing a particular object to survive in direct proportion to a degree to which the particular object possesses attributes indicating a competitive advantage in use of computing systems storage and name spaces; and/or the coordinating mechanic is formed by a plurality of peer mechanics to control the each agent, each peer mechanic being associated with a particular agent; and/or the coordinating mechanic is coupled to each of the plurality of agents.

Variations described for the present invention can be realized in any combination desirable for each particular application. Thus particular limitations, and/or embodiment enhancements described herein, which may have particular advantages to a particular application need not be used for all applications. Also, not all limitations need be implemented in methods, systems and/or apparatus including one or more concepts of the present invention.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

1. An object management system, said system coupled to a communications fabric, said system comprising:
a plurality of personal objects;
a plurality of agents, each agent associated with a particular personal object from said plurality of personal objects, said each agent providing supervision and maintenance of said particular personal object;
a coordinating mechanic to control each of said plurality of agents, wherein messages between said coordinating mechanic and each of said plurality of agents is transported via said communications fabric;
at least one scoring module to compute a score indicative of a relative probability of future utility of each particular object from said plurality of personal objects; and
a decision module to make system decisions based upon at least said relative probability.

2. An object management system as recited in claim 1, further comprising a survival module allowing a particular object to survive in direct proportion to a degree to which said particular object possesses attributes indicating a competitive advantage in use of computing systems storage and/or name spaces.

3. An object management system as recited in claim 1, wherein said coordinating mechanic includes a plurality of peer mechanics to control said each agent, each peer mechanic being associated with a particular agent.

4. An object management system as recited in claim 1, wherein said at least one scoring module is used by each of the agents.

5. An object management system as recited in claim 1, wherein said coordinating mechanic associates a coefficient for each agent based upon at least one coefficient weighting criterion, said decision module makes system decisions also based upon each said coefficient.

6. An object management system as recited in claim 5, wherein said at least one coefficient weighting criterion includes coefficient weighting criteria taken from a group of coefficient weighting criteria consisting of: historical accuracy; agent class; an agent's own confidence estimate; and any combination of these.

7. An object management system as recited in claim 5, wherein said decision module forms a sum of products of each particular object's relative probability and each particular object's coefficient.

8. An object management system as recited in claim 1, wherein said messages include messages from each agent to said coordinating mechanic, each message having information taken from a group of information consisting of: an estimate of future utility of each particular object; a cost of maintaining each particular object; a confidence factor of said estimate of future utility of each particular object, and any combination of these.

9. A method as recited in claim 1, further comprising associating at least a portion of said plurality of personal objects with at least one context.

10. A method as recited in claim 9, further comprising creating said at least one context based on execution of a task, wherein each context forming a groups of objects such that all of the objects in said group of objects are associated with said task.

11. A method as recited in claim 5, further comprising creating at least one other object in response to a user's assumption of a new task.

12. A method as recited in claim 1, wherein said relative probability is a measure of a future utility level of said particular object.

13. A method as recited in claim 1, wherein at least one of said plurality of agents provides at least one explanation of information computed by said each agent.

14. A method as recited in claim 1, wherein at least one of said plurality of agents and said coordinating mechanic is provided by a service.

15. A method as recited in claim 12, wherein said coordinating mechanic is provided by a Web service.

16. A method comprising:
providing a plurality of personal objects;
forming a plurality of agents, each agent being associated with a particular personal object from said plurality of personal objects, said each agent providing supervision and maintenance of said particular personal object;
controlling each of said plurality of agents with a coordinating mechanic.
transporting messages between said coordinating mechanic and each of said plurality of agents;
computing a score indicative of a relative probability of future utility of each particular object from said plurality of personal objects; and
making system decisions based upon at least said relative probability.

17. A method as recited in claim 16, further comprising forming said coordinating mechanic as a global mechanic.

18. An article of manufacture comprising a computer usable medium having computer readable program code means embodied therein for causing object management, the computer readable program code means in said article of manufacture comprising computer readable program code means for causing a computer to effect the steps of claim 16.

19. A program storage device readable by machine, tangibly embodying a program of instructions executable by the machine to perform method steps for object management, said method steps comprising the steps of claim 16.

20. A computer program product comprising a computer usable medium having computer readable program code means embodied therein for causing object management, the computer readable program code means in said computer program product comprising computer readable program code means for causing a computer to effect the functions of claim 1.

21. An architecture comprising a computer system comprising:
a plurality of personal objects;
a plurality of agents, each of said agents being associated with and being coupled to a unique personal object from said plurality of personal objects, each agent providing supervision and maintenance of said unique personal object;
a coordinating mechanic for controlling each of said plurality of agents;
a communications fabric coupled to said coordinating mechanic for transporting messages between said coordinating mechanic and each of said plurality of agents;
at least one scoring module coupled to said communications fabric for computing a score indicative of a relative probability of future utility of each particular object from said plurality of personal objects; and
a decision module coupled to said communications fabric for making system decisions based upon at least said relative probability.

22. An architecture as recited in claim 21, further comprising a survival module allowing a particular object to survive in direct proportion to a degree to which said particular object possesses attributes indicating a competitive advantage in use of computing systems storage and name spaces.

23. An architecture as recited in claim 21, wherein said coordinating mechanic is formed by a plurality of peer mechanics to control said each agent, each peer mechanic being associated with a particular agent.

24. An architecture as recited in claim 21, wherein said coordinating mechanic is coupled to each of said plurality of agents.
